(19) United States
(12) Patent Application Publication
(10) Pub. No.: US 2013/0015599 A1
(43) Pub. Date: Jan. 17, 2013

(54) IMPRINT APPARATUS, AND METHOD OF MANUFACTURING ARTICLE

(71) Applicant: Izumi Kawahara, Utsunomiya-shi (JP)

(72) Inventor: Izumi Kawahara, Utsunomiya-shi (JP)

(73) Assignee: CANON KABUSHIKI KAISHA, Tokyo (JP)

(21) Appl. No.: 13/542,297

(22) Filed: Jul. 5, 2012

(30) Foreign Application Priority Data
Jul. 12, 2011 (JP) 2011-154264

(51) Int. Cl. B28B 17/00; B29C 59/02

(52) U.S. Cl. 264/40.5; 425/150; 425/145

(57) ABSTRACT

The present invention provides an imprint apparatus which performs an imprint process of molding an imprint material on a substrate using a mold to form a pattern on the substrate, the apparatus including a measuring device including an off-axis detection system configured to detect a mark formed with respect to a shot region on the substrate, and configured to measure a position of the mark, and a controller configured to control the imprint process, wherein the controller is configured to control the imprint process so that measurement of the position of the mark by the measuring device, and adjustment of relative positions of the mold and the substrate based on the measurement are performed with respect to each of a plurality of shot regions on the substrate.

### BACKGROUND OF THE INVENTION

1. Field of the Invention

The present invention relates to an imprint apparatus, and a method of manufacturing an article.

2. Description of the Related Art

An imprint technique can transfer a nanoscale fine pattern and is attracting a great deal of attention as one of nanolithography techniques for mass production of semiconductor devices and magnetic storage media. In the imprint technique, a resin on a substrate (a silicon wafer or a glass plate) is cured while a mold having a fine pattern is pressed against the resin, thereby transferring (forming) the pattern of the mold onto the substrate.

The imprint technique includes several resin curing methods, and the photo-curing method is well known as one of these resin curing methods. An imprint apparatus which adopts the photo-curing method irradiates an ultraviolet-curing resin with ultraviolet rays while a transparent mold is kept in contact with the resin to expose and cure the resin, and the mold is removed (released) from the cured resin, thereby forming the pattern of the resin on a substrate.

Such an imprint apparatus adopts the dye-by-dye alignment scheme as an alignment scheme between the substrate and the mold. In the dye-by-dye alignment scheme, a mark formed in each shot region on a substrate and that formed on a mold are optically detected to correct a shift in positional relationship between the substrate and the mold. However, in the dye-by-eye alignment scheme, a mark formed on a mold is filled with a resin on a substrate when the mold contacts the resin. Since quartz commonly used as the material of a mold has nearly the same refractive index as that of a resin, a contrast required to detect a mark formed on the mold cannot be obtained when the mark is filled with the resin.

Hence, Japanese Patent No. 4185941 proposes a mold which prevents a mark formed on it from being filled with a resin on a substrate, that is, a mold having a structure in which a mark is filled with no resin, when the mold contacts the resin. This patent literature also proposes a mark formed of a material (for example, Cr) having a light-shielding effect so that the mark can be detected even if it is filled with a resin.

On the other hand, Japanese Patent Laid-Open No. 2010-080631 proposes a technique which applies the general global alignment scheme to an imprint apparatus as an alignment scheme for an exposure apparatus including a projection optical system which projects the pattern of a reticle or mask onto a substrate. In the global alignment scheme, alignment is performed based on the positions of all shot regions, which are determined by processing the detection results of marks formed in several representative shot regions (sample shot regions).

However, in the technique described in Japanese Patent No. 4185941, a mark formed on a mold is filled with no resin, so a region (mark region) on a substrate corresponding to the mark is uncovered (that is, no resin thin film is formed). This makes it difficult to uniformly process the substrate in the processes (for example, etching) after pattern transfer, thus generating a difference in etching state between the actual element pattern region and mark region on the substrate. Also, if a mark is formed of a material having a light-shielding effect, this material may peel off upon an imprint operation or mold cleaning.

On the other hand, when the global alignment scheme is applied to an imprint apparatus, the following problem is posed. In the global alignment scheme, when a mold contacts a resin on a substrate, a mark formed in each shot region is not detected, and alignment is performed based on the positions determined in accordance with the above-mentioned method. However, in the imprint apparatus, a position shift and deformation of the substrate may occur due to a force acting on it during an imprint process. Therefore, even if alignment is performed upon application of the global alignment scheme to an imprint apparatus, it is often impossible to precisely align a substrate and a mold.

### SUMMARY OF THE INVENTION

The present invention provides, for example, a technique advantageous in alignment between a mold and a substrate in an imprint apparatus.

According to one aspect of the present invention, there is provided an imprint apparatus which performs an imprint process of molding an imprint material on a substrate using a mold to form a pattern on the substrate, the apparatus including a measuring device including an off-axis detection system configured to detect a mark formed with respect to a shot region on the substrate, and configured to measure a position of the mark, and a controller configured to control the imprint process, wherein the controller is configured to control the imprint process so that measurement of the position of the mark by the measuring device, and adjustment of relative positions of the mold and the substrate based on the measurement are performed with respect to each of a plurality of shot regions on the substrate.

Further features of the present invention will become apparent from the following description of exemplary embodiments with reference to the attached drawings.

### BRIEF DESCRIPTION OF THE DRAWINGS

FIG. 1 is a schematic view showing the configuration of an imprint apparatus according to an aspect of the present invention.

FIG. 2 is an enlarged view showing the configuration of a mold in the imprint apparatus shown in FIG. 1.

FIG. 3 is a flowchart for explaining the operation of the imprint apparatus shown in FIG. 1.

FIG. 4 is a flowchart for explaining details of a process (step S314) of transferring the pattern of the mold.

FIGS. 5A to 5C are views illustrating an example of the positional relationship among the mold, a supply unit, and an off-axis detection system in the imprint apparatus shown in FIG. 1.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

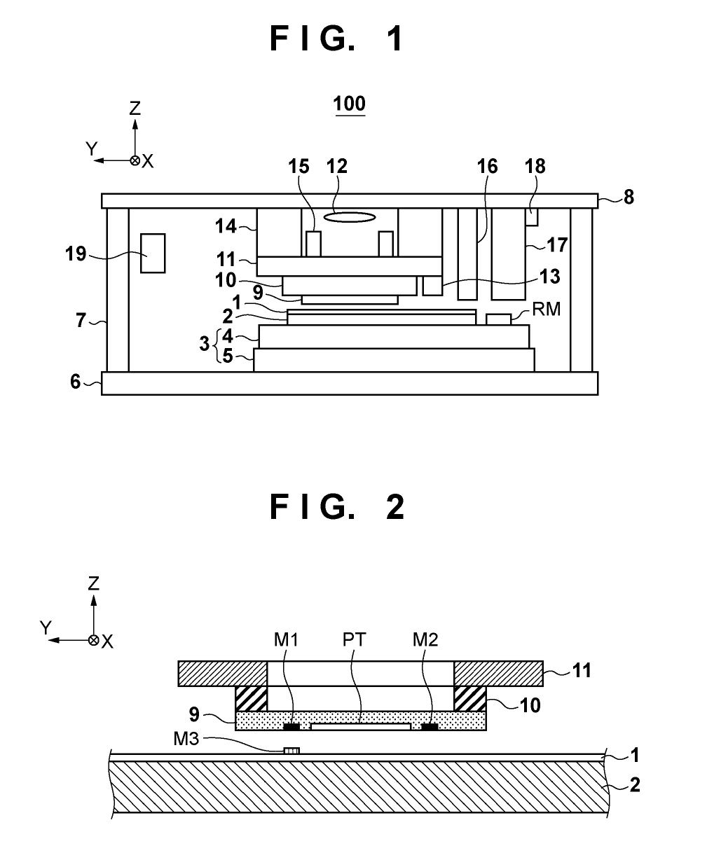

FIG. 1 is a schematic view showing the configuration of an imprint apparatus 100 according to an aspect of the present invention. The imprint apparatus 100 performs an imprint process of shaping (molding) an imprint material on a substrate using a mold to form a pattern on the substrate. More specifically, in the imprint process, an imprint material supplied onto each of a plurality of shot regions on a substrate is cured while a mold is kept in contact with the imprint material, and the mold is removed from the cured imprint material, thereby transferring the pattern of the mold onto the substrate.

Referring to FIG. 1, a substrate (wafer) 1 is held by a substrate stage 3 via a chuck 2. The substrate stage 3 includes a fine moving stage 4 and X-Y stage 5. The substrate stage 3 holds the substrate 1 and moves. The fine moving stage 4 has a function of correcting rotation of the substrate 1 about the Z-axis, that of correcting the position of the substrate 1 in the Z-axis direction, and that of correcting the tilt of the substrate 1. The fine moving stage 4 is placed on the X-Y stage 5 for positioning the substrate 1 at a predetermined position in the X- and Y-axis directions. The X-Y stage 5 is installed on a base surface plate 6. Columns 7 stand upright on the base surface plate 6, and hold a top plate 8. Also, the imprint apparatus 100 includes a position sensor (for example, a laser interferometer or a plane encoder) which measures the position of the fine moving stage 4 in the X- and Y-axis directions.

A mold 9 has on its surface a pattern (three-dimensional pattern) PT to be transferred onto the substrate 1, and is fixed on a mold chuck 10, as shown in FIG. 2. The mold chuck 10 is placed on a mold stage 11. The mold stage 11 has a function of correcting rotation of the mold 9 (mold chuck 10) about the Z-axis, and that of correcting the tilt of the mold 9. The mold chuck 10 and mold stage 11 function as a mold holding unit which holds the mold 9.

Each of the mold chuck 10 and mold stage 11 has an aperture (not shown) which passes ultraviolet light guided from a light source (not shown) via a collimator lens 12. A load cell for detecting the pressing force (imprint pressure) of the mold 9 is placed on the mold chuck 10 (or mold stage 11). Also, a gap sensor 13 for measuring the level (flatness) of the substrate 1 held by the substrate stage 3 is placed on the mold stage 11.

A mold lift actuator 14 is implemented by an air cylinder or a linear motor, and drives the mold stage 11 in the Z-axis direction to press the mold 9 held by the mold chuck 10 against the substrate 1 or separate the mold 9 held by the mold chuck 10 from the substrate 1.

A TTM (Through-The-Mold) alignment detection system 15 for mold alignment is placed on the mold stage 11. The TTM alignment detection system 15 includes an optical system and imaging system for detecting, for example, alignment marks M1 and M2 formed on the mold 9, a reference mark RM placed on the fine moving stage 4, and an alignment mark M3 formed on the substrate 1. The TTM alignment detection system 15 detects a position shift in the X- and Y-axis directions between the mold 9 and the substrate 1 held by the substrate stage 3.

A supply unit 16 is implemented by a dispenser head including a nozzle which drops a resin (a photo-curing resin in this embodiment) as an imprint material, and has a function of supplying (coating) a resin onto each shot region on the substrate 1. The supply unit 16 adopts, for example, the piezo-jet scheme or the micro-solenoid scheme to supply a resin having a very low volume (about 1 pL (picoliters)) onto the substrate 1. A resin can be coated on the substrate 1 by moving the substrate stage 3 (by scan movement or step movement) while supplying the resin from the supply unit 16.

An off-axis detection system 17 is supported by the top plate 8, and includes an optical system and imaging system for detecting, for example, the reference mark RM placed on the fine moving stage 4 and the alignment mark M3 formed on the substrate 1, without the mediacy of the mold 9. The off-axis detection system 17 detects the position of the substrate 1 (the alignment mark M3 formed on it) in the X-Y plane. In other words, the off-axis detection system 17 constitutes part of a measuring unit which measures the position of the alignment mark M3. Relative alignment between the mold 9 and the substrate 1 can be performed by obtaining the positional relationship between the mold 9 and the substrate stage 3 using the TTM alignment detection system 15, and obtaining that between the substrate stage 3 and the substrate 1 using the off-axis detection system 17.

A driving unit 18 drives the off-axis detection system 17. The driving unit 18 positions the off-axis detection system 17 based on the layout of a plurality of shot regions on the substrate 1, the position of the alignment mark M3 relative to each shot region, the resin supply (coating) rate of the supply unit 16, and the acceleration of the substrate stage 3. In other words, in the imprint apparatus 100, the driving unit 18 can change the position of the off-axis detection system 17.

A control unit 19 includes, for example, a CPU and memory and controls the overall imprint apparatus 100 (its operation). The control unit 19 controls an imprint process so that this is done after the alignment mark M3 is detected in each of a plurality of shot regions using the off-axis detection system 17, and the relative positional relationship between the substrate 1 and the mold 9 is adjusted based on the detection result.

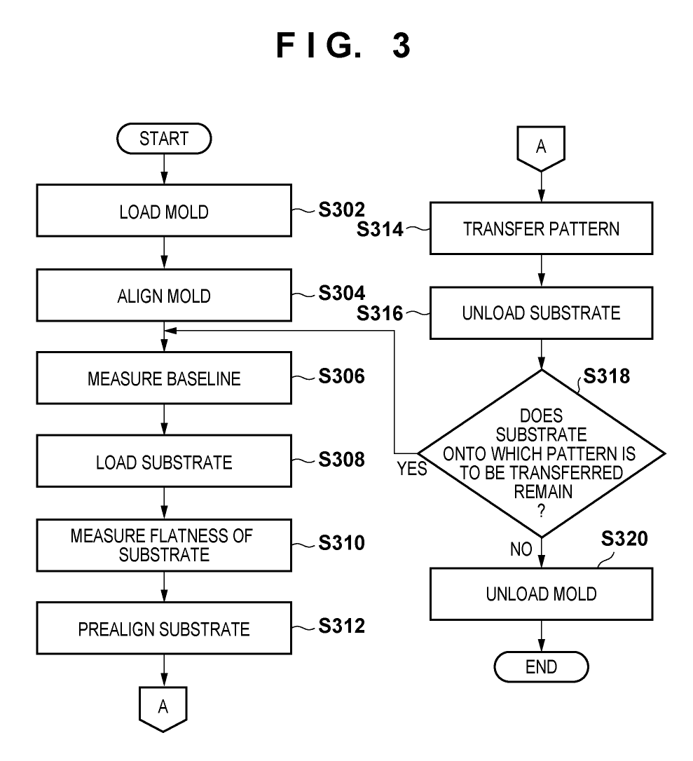

The operation of the imprint apparatus 100 will be described with reference to FIG. 3. The case wherein the pattern of a given layer is transferred onto each of a plurality of substrates 1 without changing the mold 9 will be taken as an example in this embodiment.

In step S302, a mold 9 is loaded into the imprint apparatus 100 via a mold transport mechanism (not shown), and is held on the mold stage 11 (mold chuck 10).

In step S304, the mold 9 held by the mold stage 11 is aligned. More specifically, alignment marks M1 and M2 formed on the mold 9 and a reference mark RM placed on the fine moving stage 4 are simultaneously detected by the TTM alignment detection system 15 to, in turn, detect position shifts between the alignment marks M1 and M2 and the reference mark RM. Rotation of the mold 9 about the Z-axis is mainly adjusted by the mold stage 11 based on the detection result obtained by the TTM alignment detection system 15.

In step S306, the reference mark RM placed on the fine moving stage 4 is detected by the off-axis detection system 17 to measure a baseline as the distance between the optical axis of the off-axis detection system 17 and the center of the mold 9.

In step S308, a substrate 1 is loaded into the imprint apparatus 100 via a substrate transport mechanism (not shown), and is held on the substrate stage 3 (chuck 2).

In step S310, the level (flatness) of the substrate 1 held by the substrate stage 3 is measured by the gap sensor 13. The measurement result obtained by the gap sensor 13 is required to match each shot region (its surface) on the substrate 1 with the reference surface (not shown) of the imprint apparatus 100 when the mold 9 contacts a resin on the substrate 1 (that is, when the mold 9 is pressed against the substrate 1).

In step S312, prealignment of the substrate 1 held by the substrate stage 3 is performed. More specifically, a plurality of prealignment marks (not shown) transferred onto the substrate 1 in advance are detected by a prealignment detection system. Note that the off-axis detection system 17 can also serve as the prealignment system. Position shifts of the plurality of prealignment marks relative to the mold 9 in the X- and Y-axis directions are obtained from the detection result obtained by the prealignment detection system, and rotation of the substrate 1 about the Z-axis is adjusted by the substrate stage 3 (fine moving stage 4).

In step S314, the pattern of the mold 9 is transferred onto each of a plurality of shot regions on the substrate 1. Note that a process (step S314) of transferring the pattern of the mold 9, that is, an imprint process will be described in detail later.

In step S316, the substrate 1 onto which the pattern of the mold 9 is transferred in its all shot regions is unloaded from the imprint apparatus 100 via the substrate transport mechanism.

In step S318, it is determined whether a substrate 1 onto which the pattern of the mold 9 is to be transferred remains. If no substrate 1 onto which the pattern of the mold 9 is to be transferred remains, the process advances to step S320. On the other hand, if a substrate 1 onto which the pattern of the mold 9 is to be transferred remains, the process returns to step S306, in which a baseline is measured. However, baseline measurement need not always be done for every substrate exchange, so the process may skip to step S308 if a predetermined condition is satisfied.

In step S320, the mold 9 is unloaded from the imprint apparatus 100 via the mold transport mechanism, and the operation ends.

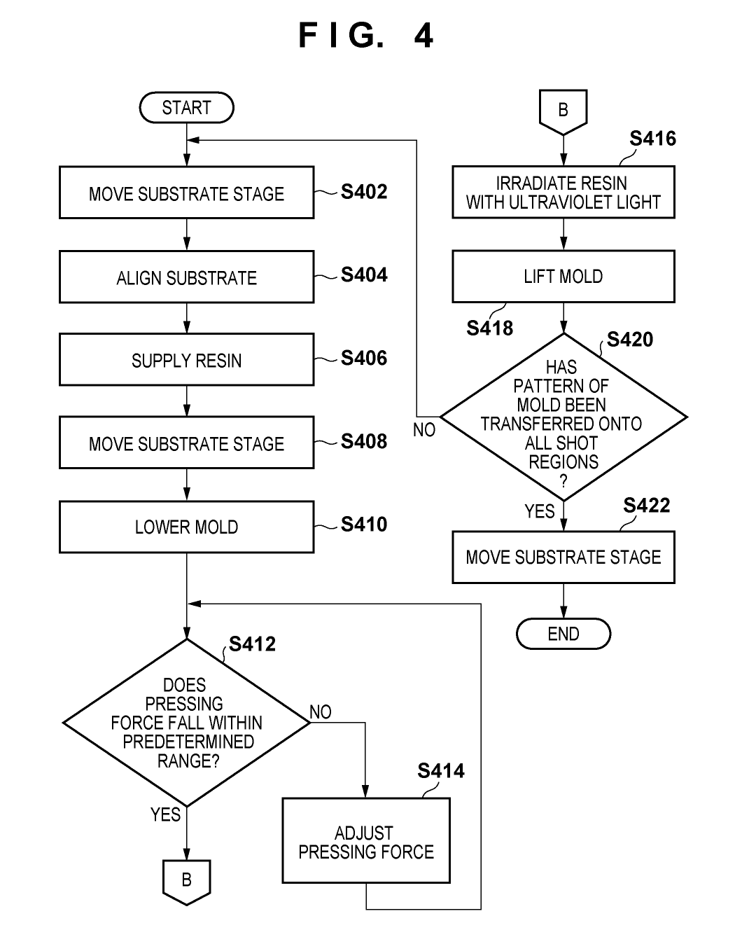

An imprint process (step S314) of transferring the pattern of the mold 9 will be described in detail with reference to FIG. 4. In step S402, the substrate stage 3 is moved so that the target shot region on the substrate 1 is positioned at the position (resin supply movement start position) at which the substrate stage 3 starts movement necessary for the supply unit 16 to supply (coat) a resin onto the substrate 1. The target shot region on the substrate 1 means herein a shot region onto which the pattern of the mold 9 is to be transferred next.

Note that if the supply unit 16 is implemented by a dispenser head including linearly arranged nozzles, the substrate stage 3 must be moved in an amount corresponding to the size of the target shot region while supplying a resin so as to coat the resin on the target shot region on the substrate 1. However, if the supply unit 16 is implemented by a dispenser head including nozzles arranged in a matrix so as to cover the shot regions on the substrate 1, a resin can be coated on the target shot region on the substrate 1 without moving the substrate stage 3.

In step S404, the substrate 1 held by the substrate stage 3 is aligned. In this embodiment, the supply unit 16 and off-axis detection system 17 are arranged so that the target shot region on the substrate 1 falls within the detection field of the off-axis detection system 17 upon positioning of this target shot region at the resin supply movement start position. Such an arrangement can be implemented by driving the off-axis detection system 17 using the driving unit 18. Therefore, with the movement of the substrate stage 3 in step S402, the substrate stage 3 falls within the detection field of the off-axis detection system 17 to have it detect the alignment mark M3 formed on the substrate 1. A position shift of the alignment mark M3 relative to the mold 9 in the X- and Y-axis directions is obtained from the detection result obtained by the off-axis detection system 17, and rotation of the substrate 1 about the Z-axis is adjusted by the substrate stage 3 (fine moving stage 4) based on the position shift. This adjusts the relative positional relationship between the mold 9 and the substrate 1.

In step S406, a resin is supplied (coated) onto the target shot region on the substrate 1 by the supply unit 16. More specifically, a resin is coated on the target shot region by moving the substrate stage 3 (performing its scan movement) from the resin supply movement start position while supplying the resin from the supply unit 16.

In step S408, the substrate stage 3 is moved so that the target shot region on the substrate 1 is positioned at the position opposed to the pattern PT of the mold 9 (that is, the position at which the mold 9 contacts the resin on the target shot region, and which will to be referred to as an “imprint process position” hereinafter). At this time, the movement target position of the substrate stage 3 (that is, the amount of movement of the substrate stage 3, which is required to position the target shot region at the imprint process position) is determined based on the detection result obtained by the off-axis detection system 17 in step S404. Also, in step S408, the position of the substrate 1 in the Z-axis direction and the tilt of the substrate 1 with respect to the X-Y plane are adjusted by the substrate stage 3 (fine moving stage 4) based on the measurement result obtained by the gap sensor 13, so that the target shot region (its surface) on the substrate 1 coincides with the reference surface of the imprint apparatus 100.

In step S410, to press the mold 9 against the target shot region on the substrate 1 (that is, to bring the mold 9 into contact with the resin on the target shot region on the substrate 1), the mold 9 is lowered to a predetermined position by the mold lift actuator 14.

In step S412, it is determined whether the pressing force of the mold 9 against the target shot region on the substrate 1 falls within a predetermined range, based on the detection result of the load cell placed on the mold chuck 10. If the pressing force of the mold 9 falls outside the predetermined range, the process advances to step S414. However, if the pressing force of the mold 9 falls within the predetermined range, the process advances to step S416. Although the pressing force of the mold 9 is detected and adjusted by the load cell in this embodiment, the gap (distance) between the mold 9 and the substrate 1 may be detected and adjusted.

In step S414, for example, the position of the mold 9 in the Z-axis direction is changed by the mold lift actuator 14 or that of the substrate 1 in the Z-axis direction is changed by the substrate stage 3 (fine moving stage 4), thereby adjusting the pressing force of the mold 9. Upon this operation, steps S412 and S414 are repeated until the pressing force of the mold 9 falls within the predetermined range.

In step S416, to cure the resin on the target shot region on the substrate 1, the resin on the target shot region is irradiated with ultraviolet light from a light source while the mold 9 is kept in contact with the resin on the target shot region.

In step S418, to separate (remove) the mold 9 from the cured resin on the target shot region on the substrate 1, the mold 9 is lifted by the mold lift actuator 14. This transfers the pattern of the mold 9 onto the target shot region on the substrate 1.

In step S420, it is determined whether the pattern of the mold 9 is transferred onto all shot regions on the substrate 1. If the pattern of the mold 9 has not been transferred onto all shot regions on the substrate 1, the process returns to step S402, in which the substrate stage 3 is moved so that the next target shot region is positioned at the resin supply movement start position. However, if the pattern of the mold 9 has been transferred onto all shot regions on the substrate 1, the process advances to step S422, in which the substrate stage 3 is moved to the unload position from which the substrate 1 onto which the pattern of the mold 9 is transferred in its all shot regions is unloaded.

In this manner, in this embodiment, an imprint process is performed in each of a plurality of shot regions while detecting the alignment mark M3 by the off-axis detection system 17, and adjusting the relative positional relationship between the substrate 1 and the mold 9 based on the detection result. Therefore, even if a position shift and deformation of the substrate 1 occur due to a force acting on it during an imprint process, the position of the alignment mark M3 (a position including the position shift and deformation) can be accurately detected for each shot region. In other words, the imprint apparatus 100 can precisely align the substrate 1 and the mold 9 for each shot region.

Also, the alignment mark M3 is detected in the period of time from when the pattern is transferred onto a first shot region among the plurality of shot regions until a resin is supplied onto a second shot region onto which the pattern is transferred subsequently to the first shot region (that is, before a resin is supplied onto the second shot region). This makes it possible to detect the alignment mark M3 formed on the substrate 1 with a sufficient contrast, thus accurately aligning the mold 9 and the substrate 1.

Note that in terms of the throughput, the substrate stage 3 desirably continues its movement in steps S404 to S408. In other words, the substrate stage 3 desirably continuously moves without stop until the target shot region is positioned at the imprint process position upon supply of a resin onto the target shot region after an alignment mark M3 in the target shot region is detected.

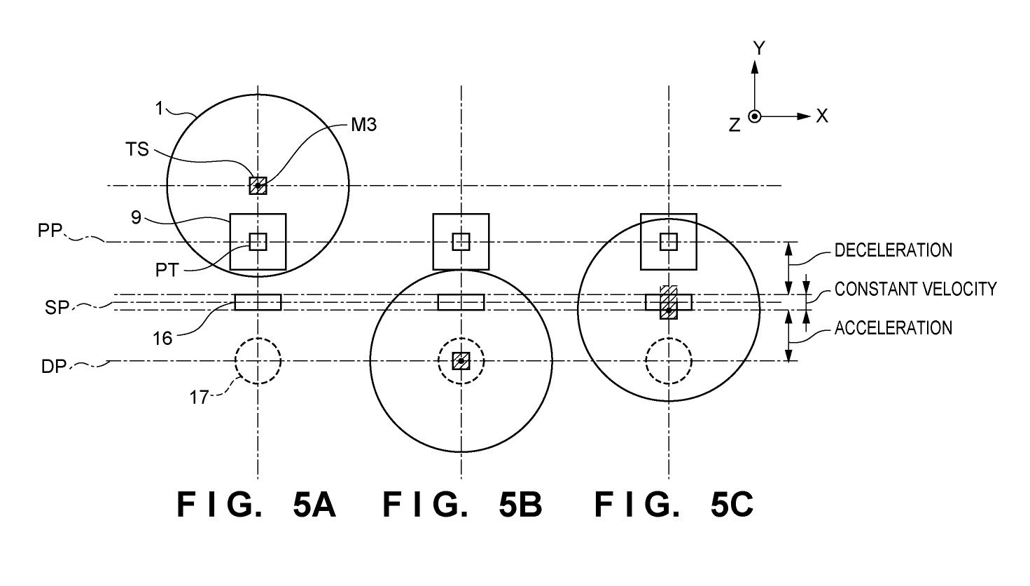

To continuously move the substrate stage 3 without stop in steps S404 to S408, the mold 9, supply unit 16, and off-axis detection system 17 are arranged as shown in, for example, FIGS. 5A to 5C. Referring to FIGS. 5A to 5C, the mold 9, supply unit 16, and off-axis detection system 17 are arranged to satisfy the following conditions (1) to (3).

Condition (1): the substrate stage 3 accelerates until the target shot region reaches a supply position (first position) SP at which a resin is supplied by the supply unit 16 after it leaves a detection position (second position) DP at which the alignment mark M3 is detected by the off-axis detection system 17.

Condition (2): the substrate stage 3 moves at a constant velocity until the target shot region passes through the supply position SP.

Condition (3): the substrate stage 3 decelerates until the target shot region reaches an imprint process position (third position) PP after it passes through the supply position SP.

FIG. 5A shows the positional relationship among the mold 9, the supply unit 16, and the off-axis detection system 17 immediately after the mold 9 is lifted (step S418), in which the pattern PT of the mold 9 is transferred onto the shot region on the substrate 1 directly below the mold 9. In the state shown in FIG. 5A, the substrate stage 3 is moved to position at the resin supply movement start position the next target shot region TS onto which the pattern PT of the mold 9 is to be transferred.

FIG. 5B shows the positional relationship among the mold 9, the supply unit 16, and the off-axis detection system 17 when the target shot region TS is positioned at the resin supply movement start position (steps S404 & S406). In supplying (coating) a resin onto the target shot region TS, the substrate stage 3 must be moved, as described above. At this time, the substrate stage 3 desirably moves at a constant velocity while the rate of supply (amount of supply) of a resin from the supply unit 16 is kept constant. Therefore, the target shot region TS is positioned at the resin supply movement start position, as shown in FIG. 5B, instead of positioning it at the supply position SP. Also, referring to FIG. 5B, the alignment mark M3 formed in the target shot region TS can be detected by the off-axis detection system 17 while the target shot region TS is positioned at the resin supply movement start position. In other words, the supply unit 16 and off-axis detection system 17 are arranged so that the resin supply start position coincides with the detection position DP. In the state shown in FIG. 5B, the substrate stage 3 accelerates until the target shot region TS reaches the supply position SP after the alignment mark M3 formed in the target shot region TS is detected by the off-axis detection system 17.

FIG. 5C shows the positional relationship among the mold 9, the supply unit 16, and the off-axis detection system 17 when the target shot region TS has reached the supply position SP (step S406). When the target shot region TS reaches the supply position SP, a resin is supplied from the supply unit 16 while the substrate stage 3 is moved at a constant velocity. Also, the substrate stage 3 decelerates until the target shot region TS reaches the imprint process position PP after a resin is coated on the target shot region TS and the target shot region TS passes through the supply position SP. Note that the period of time before the deceleration may include a constant velocity period or an acceleration period.

In this manner, degradation in throughput can be prevented by continuously moving the substrate stage 3 without stop until the target shot region TS passes through the supply position SP and reaches the imprint process position PP after it is positioned at the detection position DP.

Note that when the off-axis detection system 17 is fixed in position, the resin supply start position and the detection position DP can be matched by adjusting the acceleration of the substrate stage 3. Also, the duration (time) required to accelerate the substrate stage 3 so as to move the substrate stage 3 at a constant velocity changes depending on, for example, the moving velocity of the substrate stage 3 and the size of the target shot region TS. Therefore, the driving unit 18, for example, is desirably provided so that the position of the off-axis detection system 17 can be changed, as in this embodiment. At this time, the off-axis detection system 17 is desirably placed so as to minimize the driving time of the substrate stage 3, as shown in FIGS. 5A to 5C.

Also, referring to FIGS. 5A to 5C, the supply position SP means the center of the nozzles included in the dispenser which implements the supply unit 16. Also, the detection position DP means the center of the detection field of the off-axis detection system 17. Moreover, the imprint process position PP means the center of the mold 9.

In this embodiment, the mold 9, supply unit 16, and off-axis detection system 17 are arranged so that the center of the nozzles included in the dispenser which implements the supply unit 16, that of the detection field of the off-axis detection system 17, and that of the mold 9 are aligned on the same straight line. However, the arrangement of the mold 9, supply unit 16, and off-axis detection system 17 is not limited to this, and they need not always be aligned on the same straight line.

Also, in this embodiment, the mold chuck 10, supply unit 16, and off-axis detection system 17 are arranged so that the detection position DP, supply position SP, and imprint process position PP are aligned on a straight line in the order named. However, the mold chuck 10, supply unit 16, and off-axis detection system 17 may be arranged so that the supply position SP, detection position DP, and imprint process position PP are aligned on a straight line in the order named.

Also, if a position shift and deformation of a mold due to a force acting on it during an imprint process are expected to adversely affect alignment (overlay), they may be measured and the measurement results may be reflected on an alignment process. This measurement can be done by providing the mold stage 11 with a detection unit which detects the mark on the mold, or detecting the relative positions between the mark on the mold and the reference mark RM using the TTM alignment detection system 15.

### Embodiment of Method of Manufacturing Article

A method of manufacturing a device (for example, a semiconductor integrated circuit device or a liquid crystal display device) as an article includes a step of forming a pattern on a substrate (a wafer, a glass plate, or a film-like substrate) using the above-mentioned imprint apparatus. This method can also include a step of etching the substrate having the pattern formed on it. Note that when other articles such as a patterned medium (recording medium) or an optical element are to be manufactured, this method includes other processes of processing the substrate having the pattern formed on it, in place of etching. The method of manufacturing an article according to this embodiment is more advantageous in at least one of the performance/quality/productivity/manufacturing cost of an article than the conventional methods.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-154264 filed on Jul. 12, 2011, which is hereby incorporated by reference herein in its entirety.

What is claimed is:

1. An imprint apparatus which performs an imprint process of molding an imprint material on a substrate using a mold to form a pattern on the substrate, the apparatus comprising:
a measuring device including an off-axis detection system configured to detect a mark formed with respect to a shot region on the substrate, and configured to measure a position of the mark; and
a controller configured to control the imprint process,
wherein the controller is configured to control the imprint process so that measurement of the position of the mark by the measuring device, and adjustment of relative positions of the mold and the substrate based on the measurement are performed with respect to each of a plurality of shot regions on the substrate.

2. The apparatus according to claim 1, further comprising a supply device configured to supply the imprint material onto the shot region,
wherein the controller is configured to control the imprint process so that the detection of the mark is performed by the off-axis detection system after the imprint process is performed for a first shot region among the plurality of shot regions and before the supply of the imprint material is performed by the supply device for a second shot region to be subjected to the imprint process subsequent to the first shot region.

3. The apparatus according to claim 1, further comprising:
a supply device configured to supply the imprint material onto the shot region; and
a stage configured to hold the substrate and to be moved,
wherein the controller is configured to control the imprint process so that the movement of the stage is continued after the detection of the mark formed with respect to the shot region is performed by the off-axis detection system, and then the supply of the imprint material is performed by the supply device for the shot region, and before the shot region is positioned at an imprint process position where the imprint process is performed.

4. The apparatus according to claim 3, wherein the controller is configured to control the imprint process so that the stage is accelerated during the shot region is moved from a detection position where the detection of the mark is performed by the off-axis detection system to a supply position where the supply of the imprint material is performed by the supply device, the stage is moved at a constant velocity during the shot region is moved on the supply position, and then the stage is decelerated until the shot region reaches the imprint process position.

5. The apparatus according to claim 1, further comprising:
a holder configured to hold the mold;
a stage configured to hold the substrate and to be move; and
a supply device configured to supply the imprint material onto the shot region,
wherein the holder, the supply device, and the off-axis detection system are arranged so that a first position of the stage, where the detection of the mark is performed for the shot region by the off-axis detection system, a second position of the stage, where the supply of the imprint material is performed for the shot region by the supply device, and a third position of the stage, where the imprint process is performed for the shot region, are aligned on a straight line in an order of the first position, the second position and the third position.

6. The apparatus according to claim 5, further comprising a driving device configured to position the off-axis detection system based on a layout of the plurality of shot regions, an arrangement of the mark relative to the shot region, a rate of supply of the imprint material by the supply device, and an acceleration of the stage.

7. The apparatus according to claim 6, wherein the driving device is configured to position the off-axis detection system so that the mark can be detected for the shot region at a position of the stage where the acceleration of the stage is started to a velocity of the stage at which the supply of the imprint material is performed for the shot region by the supply device.

8. A method of manufacturing an article, the method comprising:
forming a pattern on a substrate using an imprint apparatus; and
processing the substrate, on which the pattern has been formed, to manufacture the article,
wherein the imprint apparatus performs an imprint process of molding an imprint material on the substrate using a mold to form the pattern on the substrate, the apparatus includes:
a measuring device including an off-axis detection system configured to detect a mark formed with respect to a shot region on the substrate, and configured to measure a position of the mark; and
a controller configured to control the imprint process, and
the controller is configured to control the imprint process so that measurement of the position of the mark by the measuring device, and adjustment of relative positions of the mold and the substrate based on the measurement are performed with respect to each of a plurality of shot regions on the substrate.
